(19) United States
(12) Patent Application Publication
(10) Pub. No.: US 2010/0324773 A1
(43) Pub. Date: Dec. 23, 2010

(54) Method and apparatus for relocating mobile robot

(75) Inventors: Ki-Wan Choi, Anyang-si (KR); Ji-Young Park, Yongin-si (KR); Seok-Won Bang, Seoul (KR); Hyoung-ki Lee, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/153,529

(22) Filed: May 20, 2008

(30) Foreign Application Priority Data
Jun. 28, 2007 (KR) 10-2007-0064606

(51) Int. Cl. G05D 1/00; B25J 5/00

(52) U.S. Cl. 701/26; 901/1

(57) ABSTRACT

Provided is a method and apparatus for relocating a mobile robot when the mobile robot loses its position due to slipping. The method includes storing a moving path of the mobile robot and effective points on the moving path capable of finding an absolute position from a peripheral image; detecting an abnormal motion of the mobile robot; and when the abnormal motion of the mobile robot is detected, controlling the mobile robot to move to the effective point along a predetermined return path.

### CROSS REFERENCE TO RELATED APPLICATION

This application claims priority from Korean Patent Application No. 10-2007-0064606 filed on Jun. 28, 2007 in the Korean Intellectual Property Office, the disclosure of which is incorporated herein by reference in its entirety.

### BACKGROUND OF THE INVENTION

1. Field of the Invention

The present invention relates to a mobile robot, and more particularly, to a method and apparatus for relocating a mobile robot when the mobile robot loses its position due to slipping.

2. Description of the Related Art

In general, industrial robots were developed to improve factory automation, and are used to perform manufacturing processes in extreme environments in which humans cannot work. In recent years, robotics technology has been used in the space industry, which has lead to the development of human-friendly home service robots. In addition, robots have been inserted into the human body instead of medical instruments to treat a minute cellular texture which is untreatable by existing medical instruments. Robotics technology has drawn attention as a high-tech technology that will follow the information revolution caused by the development of the Internet and biotechnology.

Home service robots, such as cleaning robots, have played a leading role in the expansion of the robotics technology focused on industrial robots used for only heavy industries to robotics technology focused on light industries. The cleaning robot generally includes a driving unit for movement, a cleaning unit, and a positioning unit for measuring the position of a user or a remote controller.

In the mobile robots, such as cleaning robots, it is a basic and important function to check its exact position. The absolute position of the mobile robot can be calculated by the following methods: installing a beacon having an ultrasonic sensor in the home or the indoor GPS (global positioning system). In addition, the relative position of the mobile robot can be calculated by the following methods: calculating the rotational speed of a mobile robot and the linear speed of the mobile robot using an encoder and integrating the speeds; integrating an acceleration value obtained by an acceleration sensor twice; and integrating the rotational speed of the mobile robot, which is the output of a gyrosensor, to calculate the distance travelled.

However, when the mobile robot loses its current position due to an abnormal motion, such as slipping, during a SLAM (simultaneous localization and map building) process, a process of relocating the mobile robot must be performed. However, when the slipping occurs, the value measured by the encoder or an odometer is unreliable. Therefore, the relocation process should be performed using another sensor.

The slipping includes slipping in a straight direction and slipping in a rotational direction. The slipping in the straight direction can be corrected by the acceleration sensor, and the slipping in the rotational direction can be corrected by the gyrosensor. Acceleration sensors produce errors that are smaller than those of gyrosensors, but the performances of the sensors vary. This is because the error of the acceleration sensor accumulates by two integration processes. When slipping occurs in the mobile robot, it is difficult to calculate the exact relative position of the mobile robot using the acceleration sensor or the gyrosensor.

Therefore, when slipping occurs in the mobile robot, a method of calculating the absolute position of the mobile robot to relocate the mobile robot is needed. In the method of calculating the absolute position of the mobile robot, a technique for using an image captured by a camera provided in a mobile robot has been proposed. This technique calculates the absolute position of the mobile robot as follows: the camera provided in the mobile robot captures the image of an object referring to the absolute position of the mobile robot, such as a ceiling, a wall, or a floor; feature points are extracted from the captured image; and the mobile robot compares the extracted feature points with feature points obtained while moving in real time.

However, when the mobile robot is placed at a position where the feature points cannot be acquired due to slipping during the SLAM process, it is difficult to relocate the mobile robot. This situation may occur, for example, when the number of feature points included in a captured image is insufficient to calculate the absolute position of the mobile robot.

### SUMMARY OF THE INVENTION

An object of the invention is to provide an apparatus and method for effectively relocating a mobile robot when the mobile robot loses its position while moving.

In particular, the object of the invention is to provide an apparatus and method for relocating a mobile robot that updates a point capable of relocating a mobile robot traveling normally, and controlling the mobile robot to move the updated point when slipping occurs.

Objects of the present invention are not limited to those mentioned above, and other objects of the present invention will be apparent to those skilled in the art through the following description.

According to an aspect of the present invention, there is provided a method of relocating a mobile robot, the method including storing a moving path of the mobile robot and effective points on the moving path capable of finding an absolute position from a peripheral image; detecting an abnormal motion of the mobile robot; and when the abnormal motion of the mobile robot is detected, controlling the mobile robot to move to the effective point along a predetermined return path.

According to an aspect of the present invention, there is provided an apparatus for relocating a mobile robot, the apparatus including a storage unit storing a moving path of the mobile robot; an effective-point storage unit storing effective points on the moving path capable of finding an absolute position from a peripheral image; a detecting unit detecting an abnormal motion of the mobile robot; and a relocation unit controlling the mobile robot to move to the effective point along a predetermined return path when the abnormal motion of the mobile robot is detected.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The above and other features and advantages of the present invention will become apparent by describing in detail preferred embodiments thereof with reference to the attached drawings in which:

FIG. 1 is a block diagram illustrating the structure of a mobile robot 100 according to an embodiment of the invention;

FIG. 2 is a block diagram illustrating feature points extracted from a ceiling image;

FIG. 3 is a diagram illustrating the positions of effective points on a moving path of the mobile robot;

FIG. 4 is a diagram illustrating a moving path and a return path that is symmetric to the moving path with respect to a line;

FIG. 5 is a diagram illustrating a moving path and a return path that is symmetric to the moving path with respect to a point;

FIG. 6 is a diagram illustrating return paths from several points to a final effective point;

FIGS. 7 and 8 are diagrams illustrating a relocation process according to a first embodiment of the invention;

FIGS. 9 and 10 are diagrams illustrating a relocation process according to a second embodiment of the invention; and

FIGS. 11 and 12 are diagrams illustrating a relocation process according to a third embodiment of the invention.

### DESCRIPTION OF THE PREFERRED EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which preferred embodiments of the invention are shown.

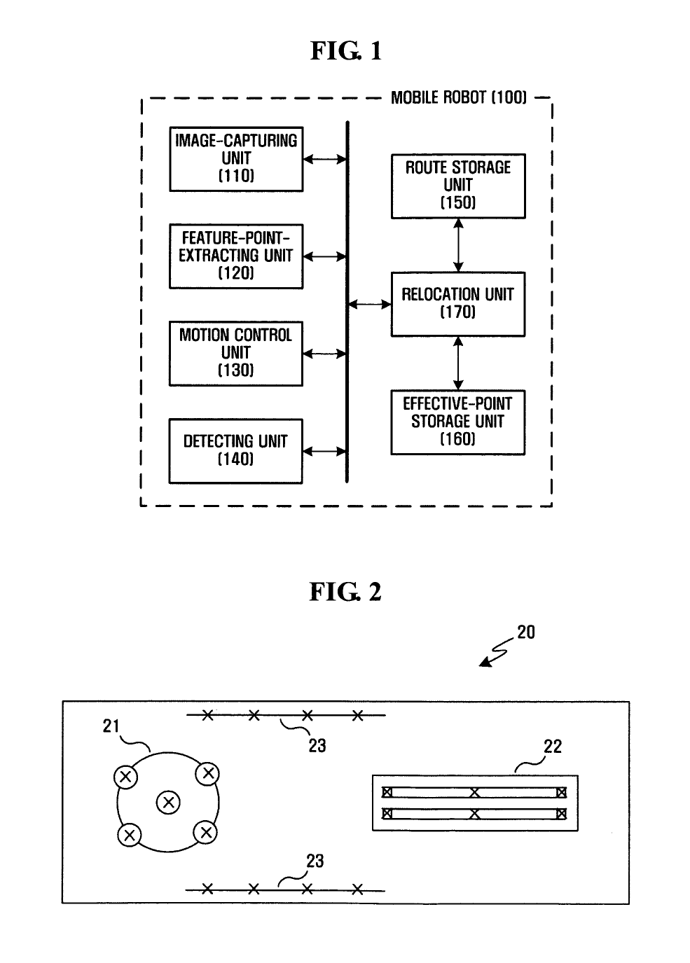

FIG. 1 is a block diagram illustrating the structure of a mobile robot 100 according to an embodiment of the invention. The mobile robot 100 may include an image-capturing unit 110, a feature-point-extracting unit 120, a motion control unit 130, a detecting unit 140, a path storage unit 150, an effective-point storage unit 160, and a relocation unit 170.

The image-capturing unit 110 captures a peripheral image suitable for extracting feature points. The peripheral image may include a ceiling image, a wall image, and a floor image, but the image of the ceiling is most suitable for the peripheral image because the ceiling has a lighting that has little variation in image and is suitable for extracting feature points provided thereon. In the present embodiment of the invention, the ceiling image is used as the peripheral image. The image-capturing unit 110 may be composed of one of a CCD (charge coupled device), a CMOS (complementary metal oxide semiconductor), and other image-capturing devices, and includes an A/D (analog-to-digital) converter for converting analog signals of a captured image to digital signals.

The feature-point-extracting unit 120 extracts one or more feature points from the ceiling image captured by the image-capturing unit 110. The feature points are used to identify a specific position on the ceiling image. The feature points may be points indicating characteristics of the specific position. For example, when a ceiling image 20 shown in FIG. 2 is captured, the ceiling image 20 may include detailed images of a chandelier 21, a fluorescent lamp 22, and edges 23 that are discriminated from other positions. When a plurality of feature points are indicated on the detailed images and the mobile robot 100 detects the indicated feature points on the captured image while moving, it is possible to check the absolute position of the mobile robot 100.

The motion control unit 130 controls the mobile robot 100 to move to a desired position. For example, the motion control unit 130 may include a plurality of traveling wheels, a motor for driving the traveling wheels, and a motor controller for controlling the motor. The mobile robot 100 has a rectilinear motion by making the rotational speeds of the plurality of driving wheels equal to each other, and the mobile robot 100 achieves curvilinear motion by making the rotational speeds of the plurality of driving wheels different from each other.

The detecting unit 140 detects whether an abnormal motion (for example, a slip) occurs in the mobile robot 100 while the mobile robot 100 is moving. Specifically, the detecting unit 140 can detect the abnormal motion of the mobile robot 100 using an encoder and an inertial sensor (for example, a gyrosensor or an acceleration sensor). The encoder is connected to the traveling wheels included in the motion control unit 130 to detect the rotational speed of the traveling wheels. The rotational speed detected by the encoder is integrated to calculate the traveling distance and direction of the mobile robot 100. Therefore, in a space in which it is difficult to calculate the absolute position of the mobile robot 100 using the ceiling image because there are insufficient feature points, the encode can be used to know the position and direction of the mobile robot 100. However, when slipping occurs in the motion of the mobile robot 100, the method of using the encoder to measure the position of the mobile robot 100 is useless. The detecting unit 140 determines that the slipping occurs when the difference between the current position measured by the encoder and the current position measured by the inertial sensor is larger than a threshold value.

However, when the mobile robot 100 cannot calculate the absolute position from the ceiling image, a separate relocation process is needed. For example, when the number of feature points on the captured ceiling image is insufficient to determine the current position or when the mobile robot 100 has not yet generated the feature points at the current position because it is performing SLAM, the mobile robot 100 cannot calculate the absolute position from the ceiling image.

The path storage unit 150 stores the path of the mobile robot 100 to the current position (hereinafter, referred to as a “moving path”) in real time. The moving path can be represented by sets of two-dimensional coordinates, and the coordinates may be stored at predetermined time intervals or at predetermined gaps. The coordinates can be calculated by a method of calculating the absolute position using the ceiling image. However, in the section in which the absolute position cannot be calculated from the ceiling image, the encoder is complementarily used to calculate the coordinates of the mobile robot 100.

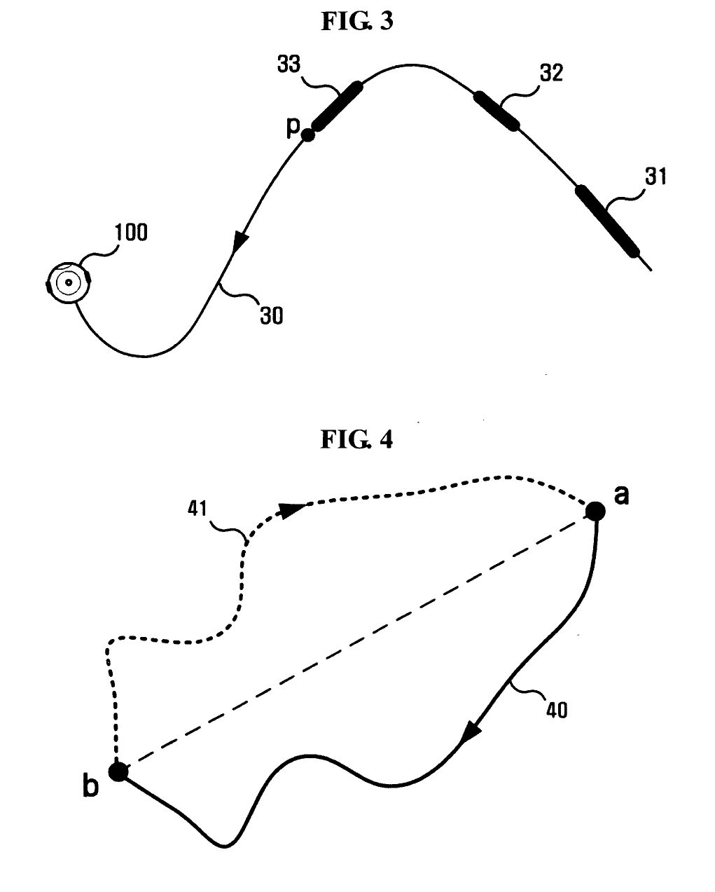

The effective-point storage unit 160 stores points on the moving path where the absolute position can be calculated using the ceiling image (hereinafter, referred to as “effective points”). For example, when the mobile robot 100 moves along a path 30 shown in FIG. 3, the absolute position cannot be calculated at all of the points on the path 30, as described above. Therefore, the effective-point storage unit 160 stores points 31, 32, and 33 on the path 30 where the absolute position can be calculated using the ceiling image, that is, effective points, preparing for a subsequent relocating process. The effective-point storage unit 160 may store a plurality of effective points, but in the actual relocation process, a final effective point p is sufficient to calculate the absolute position. Therefore, preferably, the effective-point storage unit 160 may store only the final effective point p. That is, the effective-point storage unit 160 updates effective points in real time.

When the detecting unit 140 detects slipping from the motion of the mobile robot 100, the relocation unit 170 performs a relocation process for finding the current position of the mobile robot 100.

FIGS. 4 and 6 are diagrams illustrating the basic concept of relocation according to an embodiment of the invention. As shown in FIG. 4, a path 40 from a first point a to a second point b, and a return path 41 from the second point b to the first point a are symmetric with respect to a line linking the two points a and b.

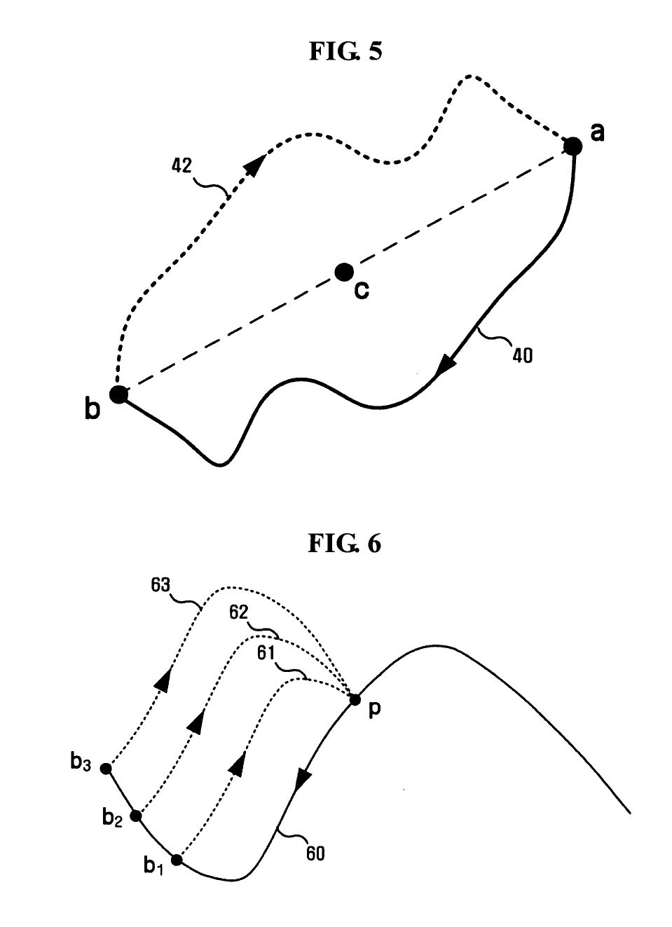

Similarly, as shown in FIG. 5, the path 40 and a return path 42 from the second point b to the first point a are symmetric with respect to a point c, or are rotationally symmetric.

When slipping occurs in the motion of the mobile robot 100 at the second point b, and the first point a is a final effective point, the mobile robot 100 should move to the first point a through any path in order for relocation. However, when the slipping occurs, the mobile robot 100 cannot know its current position, it is difficult for the mobile robot 100 to move the path 41 or the path 40 that is symmetric to the path 41 with respect to the line.

Therefore, according to an embodiment of the invention, the mobile robot 100 moves from the point where the slipping occurs along the path 42 that is symmetric to the path 40 with respect to the point c to reach the first point a, which is the final effective point.

This will be described in more detail with reference to FIG. 6. When slipping occurs at a point while the mobile robot 100 is moving along a path 60 via the final effective point p, the mobile robot 100 loses its position, and it may be disposed at one of the points b1 to b3 or any other point. In this state, when the mobile robot 100 moves from any one of the points b1 to b3 along a path 61, 62 or and 63 that is symmetric to the path 60 with respect to a point, it will reach the final effective point p. In this case, the mobile robot 100 moves from any one of the points b1 to b3 to the final point p in the same direction, but it is uncertain when the mobile robot 100 will encounter the final effective point p.

Therefore, in order to determine whether the mobile robot encounters the final effective point p, the relocation unit 170 compares feature points obtained from an image that is captured in real time while the mobile robot 100 is moving to the final effective point p with feature points obtained from the final effective point p at all times. When the feature points are matched, the mobile robot 100 has reached the final effective point p.

Once the mobile robot 100 reaches the final effective point p, the mobile robot 100 obtains its position from absolute coordinates (known coordinates) of the final effective point p, and the relocation process is completed.

The components shown in FIG. 1 may be composed software components, such as tasks, classes, sub-routines, processes, objects, execution threads, and programs, hardware components, such as a field-programmable gate array (FPGA) and an application specific integrated circuit (ASIC), or combinations of the software components and the hardware components. The components may be stored in a computer-readable storage medium, or they may be dispersed in a plurality of computers.

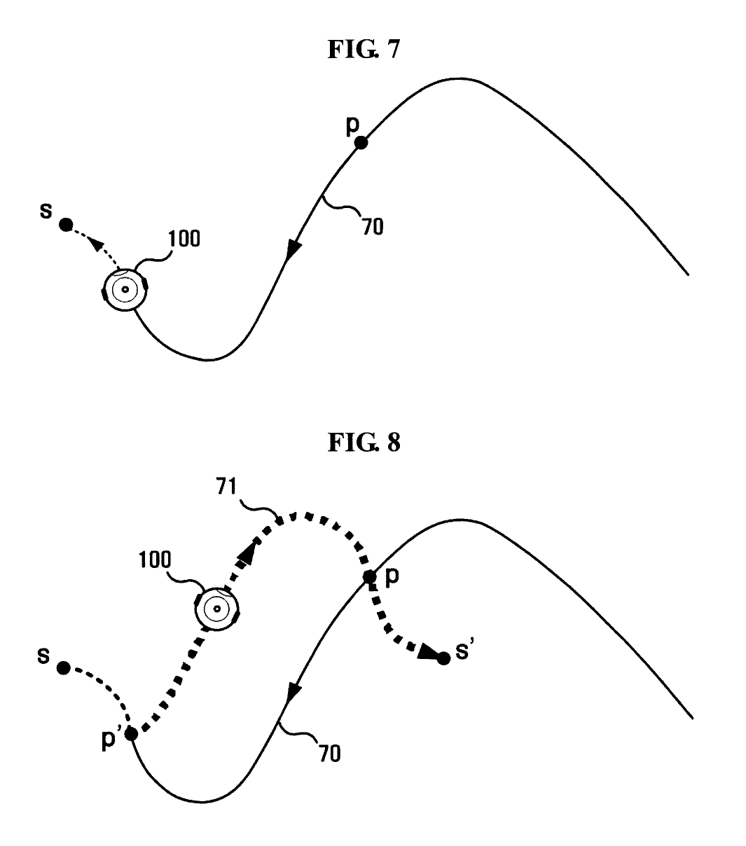

FIGS. 7 to 12 are diagrams illustrating relocation processes according to embodiments of the invention. FIGS. 7 and 8 are diagrams illustrating a relocation process according to a first embodiment of the invention.

When slipping occurs in the mobile robot 100 moving along a path 70, the final position p′ of the mobile robot 100 deviates from the position s of the mobile robot 100 calculated by the encoder. In this case, the relocation unit 170 controls the mobile robot 100 to move along a return path 71 that is symmetric to a path 70 from the point p′ to the final effective point p with respect to a point, and controls the feature-point-extracting unit 120 to extract feature points of the ceiling image. Then, the relocation unit 170 determines whether the extracted feature points are matched with the feature points at the final effective point p at all times. When the feature points are matched with each other, the mobile robot 100 is disposed at the final effective point p. The final effective point p is found when the mobile robot 100 reaches a point s′ that is symmetric to the position s calculated by the encoder with respect to a point.

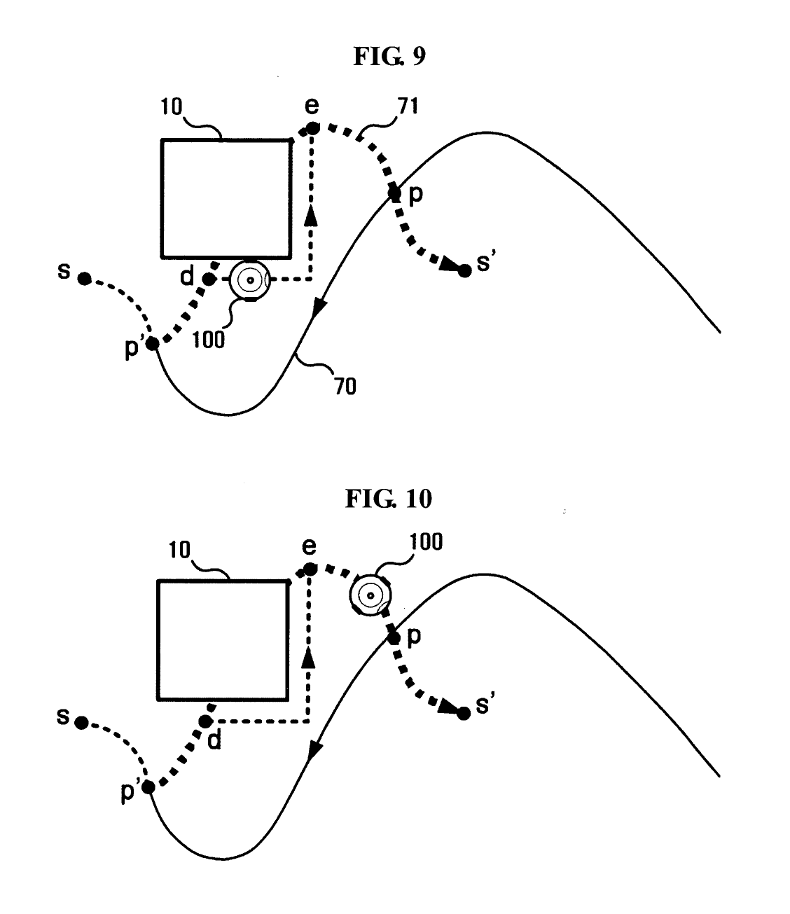

FIGS. 9 and 10 are diagrams illustrating a relocation process according to a second embodiment of the invention. The second embodiment differs from the first embodiment in that an obstacle 10 is placed on the path. While the mobile robot 100 is moving from the final position p′ to the final effective point p along the return path 71, the mobile robot 10 encounters the obstacle 10. In this case, the relocation unit 170 controls the mobile robot 100 to perform a wall-following process to move along the contour of the obstacle 10, not along the return path 71.

When the mobile robot 100 encounters one point on the return path 71 during the wall-following process, the relocation unit 170 controls the mobile robot 100 to move along the return path 71, as shown in FIG. 10. In this way, the mobile robot 100 can reach the final effective point p. The obstacle 10 may exist in the space in which the mobile robot 100 moves, but the obstacle 10 is less likely to exist at the final effective point p. This is because the mobile robot 100 has already passed through the final effective point p.

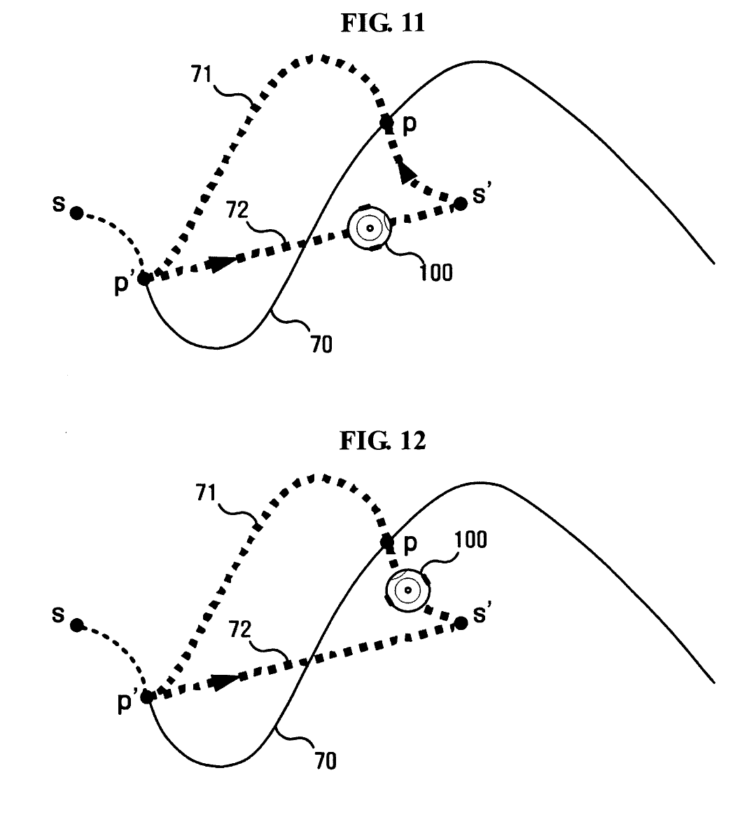

FIGS. 11 and 12 are diagrams illustrating a relocation process according to a third embodiment of the invention. The third embodiment uses a different manner from those in the first and second embodiments to enable the mobile robot 100 to reach the final effective point p. The relocation unit 170 can exactly know a final point of a path 71 that is symmetric to the moving path 70 of the mobile robot 100 with respect to a point, that is, a point s′ corresponding to the position s calculated by the encoder. Therefore, first, the relocation unit 170 controls the mobile robot 100 to move straight from the final position p′ to the point s′.

When the mobile robot 100 reaches the point s′, the relocation unit 170 controls the mobile robot 100 to move along the path 71. Thereafter, the relocation unit 170 extracts feature points from the ceiling image, and determines whether the extracted feature points are matched with feature points at the final effective point p at all times. When the feature points are matched with each other, the mobile robot 100 is displaced at the final effective point p.

As described above, according to the embodiments of the invention, it is possible to effectively relocate a mobile robot when the mobile robot loses its position.

Although the embodiments of the invention have been described above with reference to the accompanying drawings, it will be apparent to those skilled in the art that various modifications and changes may be made thereto without departing from the scope and spirit of the invention. Therefore, it should be understood that the above embodiments are not limitative, but illustrative in all aspects.

1. A method of relocating a mobile robot, comprising:
storing a moving path of the mobile robot and effective points on the moving path capable of finding an absolute position from a peripheral image;
detecting an abnormal motion of the mobile robot; and
when the abnormal motion of the mobile robot is detected, controlling the mobile robot to move to the effective point along a predetermined return path.

2. The method of claim 1, wherein the peripheral image is a ceiling image, a wall image, or a floor image.

3. The method of claim 1, wherein the effective point is a final effective point among the effective points on the moving path capable of finding the absolute position from the peripheral image.

4. The method of claim 1, wherein the abnormal motion is slipping.

5. The method of claim 1, wherein the abnormal motion is detected by comparing a value measured by an encoder with a value measured by an inertial sensor.

6. The method of claim 5, wherein the inertial sensor is a gyrosensor or an acceleration sensor.

7. The method of claim 1, wherein the return path is calculated on the basis of the moving path.

8. The method of claim 7, wherein the return path is symmetric to the moving path with respect to a point.

9. The method of claim 8, wherein a reference point for the point symmetry is a central point between the current position of the mobile robot and the effective point.

10. The method of claim 9, further comprising:
when the mobile robot encounters an obstacle while moving along the return path, controlling the mobile robot to move along the contour of the obstacle until the mobile robot encounters the return path again.

11. The method of claim 1, wherein the return path includes the effective point and a corresponding point that is symmetric to the position calculated by the encoder with respect to a point after the abnormal motion occurs.

12. The method of claim 1, further comprising:
determining whether the mobile robot reaches the effective point in real time.

13. The method of claim 12, wherein:
the determining of the reaching of the mobile robot to the effective point comprises:
determining whether feature points obtained from an image captured in real time are matched with feature points obtained from the effective point.

14. An apparatus for relocating a mobile robot, comprising:
a storage unit storing a moving path of the mobile robot;
an effective-point storage unit storing effective points on the moving path capable of finding an absolute position from a peripheral image;
a detecting unit detecting an abnormal motion of the mobile robot; and
a relocation unit controlling the mobile robot to move to the effective point along a predetermined return path when the abnormal motion of the mobile robot is detected.

15. The apparatus of claim 14, wherein the peripheral image is a ceiling image, a wall image, or a floor image.

16. The apparatus of claim 14, wherein the effective point is a final point among the effective points on the moving path capable of finding the absolute position from the peripheral image.

17. The apparatus of claim 14, wherein the abnormal motion is slipping.

18. The apparatus of claim 14, wherein the detecting unit detects the abnormal motion by comparing a value measured by an encoder with a value measured by an inertial sensor.

19. The apparatus of claim 18, wherein the inertial sensor is a gyrosensor or an acceleration sensor.

20. The apparatus of claim 14, wherein relocation unit calculates the return path on the basis of the moving path.

21. The apparatus of claim 20, wherein the relocation unit calculates the return path that is symmetric to the moving path with respect to a point.

22. The apparatus of claim 21, wherein a reference point for the point symmetry is the central point between the current position of the mobile robot and the effective point.

23. The apparatus of claim 22, wherein, when the mobile robot encounters an obstacle while moving along the return path, the relocation unit controls the mobile robot to move along the contour of the obstacle until the mobile robot encounters the return path again.

24. The apparatus of claim 14, wherein the return path includes the effective point and a corresponding point that is symmetric to the position calculated by the encoder with respect to a point after the abnormal motion occurs.

25. The apparatus of claim 14, wherein the relocation unit determines whether the mobile robot has reached the effective point in real time.

26. The apparatus of claim 25, wherein the relocation unit determines whether the mobile robot has reached the effective point on the basis of whether feature points obtained from an image captured in real time match feature points obtained from the effective point.
